(19) United States
(12) Patent Application Publication
(10) Pub. No.: US 2009/0153053 A1
(43) Pub. Date: Jun. 18, 2009

(54) LOW MERCURY CERAMIC METAL HALIDE LAMP

(75) Inventor: Andrew Lawrence Podevels, University Heights, OH (US)

Correspondence Address: Fay Sharpe LLP, 1228 Euclid Avenue, 5th Floor, The Halle Building, Cleveland, OH, 44115, US

(73) Assignee: General Electric Company

(21) Appl. No.: 11/958,837

(22) Filed: Dec. 18, 2007

(51) Int. Cl. H01J 61/20; H01J 9/395

(52) U.S. Cl. 313/639; 445/53

(57) ABSTRACT

This disclosure relates to a low mercury content, metal halide lamp having a ceramic arc tube with an aspect ratio ranging from approximately 1.15 up to about 4.75, and having a fill in the arc tube of up to 2 milligrams of mercury per cubic centimeter and up to 10 milligrams of zinc metal and/or zinc/zinc iodide per cubic centimeter.

### BACKGROUND OF THE DISCLOSURE

The present disclosure relates to metal halide lamps. It finds particular application with regard to low mercury ceramic metal halide lamps. However, it is to be appreciated that the present disclosure will have wide application throughout the lighting industry.

Metal halide lamps are widely used because they have a higher efficiency than incandescent lamps. This is economically and environmentally beneficial. The mercury content in the lamp dose generally contributes to lamp performance by enhancing voltage generation, by functioning as a buffer gas for the arc, and by reducing free iodine generated during lamp operation. However, these lamps have historically contained high amounts of mercury, which is considered an environmentally undesirable material.

Attempts have been made to reduce the amount of mercury contained in metal halide lamps without sacrificing lamp performance. For example, mercury-free metal halide lamps have been proposed. In some instances, the fill in such lamps may comprise an inert gas which acts as a buffer gas, a compound of a halogen with a metal of, for example, hafnium and/or zirconium, that is used to bolster voltage generation and as a cycle promoter, a further metal halide material to act as a light generator, and as a vaporizer. This type of lamp, however, experiences performance degradation as compared to conventional mercury-containing lamps.

Another mercury-free metal halide lamp design has been suggested wherein the lamp envelope is comprised of fused silica and has an aspect ratio greater than five (where the aspect ratio is generally defined as the arc length divided by the bore diameter). This type of lamp includes xenon, argon, or krypton and a metal halide fill. Again, due to the very high aspect ratio, this lamp design may not always be optimal.

In both the foregoing. performance suffers due at least in part to the complete lack of mercury.

An alternative to the foregoing mercury-free metal halide lamp designs has been a reduction in the amount of mercury included in the metal halide lamp. However, such advances have historically been accompanied by the need to have a high aspect ratio and/or specifically shaped quartz vessels, for example, ellipsoidally-shaped envelopes.

As the foregoing demonstrates, several means have been used to address the need to replace all or some of the mercury in metal halide lamps. However, such replacement engenders problems with regard to other lamp features. For example, conventional lamp technology has included the use of quartz as the arc tube material. Quartz has been a material of choice because of its low cost and the ease with which it can be formed and shaped to accommodate lamp design variations. However, such vessels have a limited wall temperature and a corresponding limit to the halide components that can be employed with the quartz vessels.

An alternative fill gas that has been suggested is xenon. The vapor pressure of the xenon fill is very high, in excess of one atmosphere. However, this lamp requires a large starting voltage. One means to accommodate this drawback has been limiting the lamp to very specific applications, i.e., for use in street lighting, this being due to poor color properties in lamps of this type.

The problem of replacement or reduction of the mercury content in metal halide lamps is critical because mercury performs many functions in a metal halide lamp. Therefore, each function must be performed by any replacement material, or combination of replacement materials. For example, the mercury functions as a voltage generator, a buffer gas, and as a means of reducing I₂ formation. Therefore, in replacing or reducing the amount of mercury, it is necessary to address the problems which arise with regard to these functions of mercury within the metal halide lamp.

What is needed in the industry is a solution to the environmental issues attendant to the use of mercury in metal halide lamps without sacrificing the advantages gained with regard to voltage generation, buffer gas., and reduction of I₂ formation in developing a replacement for the mercury, and while maintaining overall lamp performance.

### SUMMARY

A low mercury metal halide lamp having a ceramic arc tube having an aspect ratio of up to about 4.75 is described.

The low mercury lamp preferably has a fill in the arc tube of up to 2 milligrams of mercury per cubic centimeter.

The low mercury lamp preferably includes up to 10 milligrams of zinc metal and/or zinc/zinc iodide per cubic centimeter.

### BRIEF DESCRIPTION OF THE DRAWINGS

FIG. 1 is a diagram of a lamp according to the disclosure.

### DETAILED DESCRIPTION

It has now been determined as described below in connection with the present disclosure that a reduction may be made in the mercury content of a metal halide lamp without sacrificing lamp performance. Specifically, the metal halide lamp of the present disclosure preferably includes a polycrystalline aluminum (PCA) vessel having an aspect ratio of up to about 4.75 that contains up to 2 milligrams per cubic centimeter of mercury in combination with up to 10 milligrams per cubic centimeter of zinc, as zinc metal or as a combination of zinc metal and zinc iodide. The metal halide lamp further contains standard components in terms of noble gasses (helium, neon, argon, krypton, xenon, or combinations thereof) at a cold pressure of between 25 and 760 torr as the lamp fill, metal halides, such as NaI, TlI, CeI₃, CaI₂, and other such metal halides or any combination thereof, as the lamp dose, conventional electrodes, conventional seal glass and sealing mechanisms, and a conventional evacuated jacket. The lamp uses conventional electronic or magnetic ballast power supply, and operates to provide lamp performance equal to or better than conventional metal halide lamps but without the high mercury content, that is typically on the order of 4-5 mg/cc or more of mercury.

The aspect ratio of a metal halide lamp in keeping with the invention is up to 4.75. Again. “aspect ratio”, as used herein, is defined as the arc length divided by the bore diameter. With regard to the current disclosure, the aspect ratio is limited on the upper end with regard to the length of the lamp by the voltage needed to start the lamp. For example, a lamp operated on commercially available power supplies may have a maximum length of about 40 mm, and generally it is not desirable to increase the length above 40 mm. Starting voltage is also a function of fill pressure. So, it is possible to have a lower pressure lamp that is longer, but such a lamp generally will not perform as well. Therefore, in keeping with an aspect ratio of up to 4.75, the maximum diameter of a 40 mm lamp is about 32 mm. The lower end of the range for the diameter of the lamp is limited by manufacturing considerations and is about 5 mm outer diameter. With this in mind, the minimum length that can be conveniently manufactured in a commercial process to be within the noted aspect ratio recited is 6.25 mm. Generally, the arc tube of the subject disclosure has a cylindrical shape, and approximately right-angle ends, as opposed to ellipsoidal shaped ends which other lamp designs employ. While the subject disclosure has been tested in cylindrical lamp applications, it will be appreciated by one skilled in the art that certain other lamp designs may benefit from the use of an aspect ratio in keeping with the design parameters proposed herein.

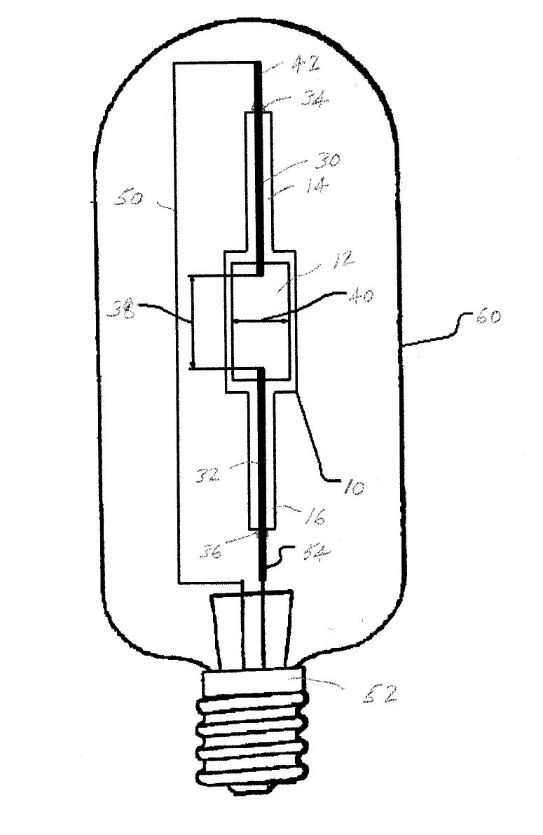

Now then with regard to the lamp and with reference to FIG. 1, a CMH lamp of the type under consideration includes a body or vessel 10 having a cavity or arc discharge chamber 12. First and second hollow legs 14, 16 extend from the body. Openings in the legs receive electrode/lead wire assemblies 30, 32, respectively, that are connected to an external power source (not shown). In addition, seals 34, 36 are provided at each outer end of the legs to hermetically seal the electrode assemblies relative to the legs. For example, a preferred seal is a frit seal that is typically provided along a portion of the lead wire assembly. An inner end of each electrode/lead wire assembly extends into the discharge chamber and is spaced apart by a predetermined distance that is defined as an arc gap or arc length indicated by reference numeral 38. An internal or bore diameter 40 of the arc chamber is also referenced in FIG. 1.

An axial outer portion or outer lead portion 42 of the first electrode/lead wire assembly is electrically and mechanically connected to a source of power (not shown), more particularly. via connection to elongated support 50 that extends from a lamp base 52. Likewise, the second electrode/lead wire assembly includes an outer portion or outer lead portion 54 that is electrically and mechanically connected to the lamp base 52. The lamp 20 may be received in an outer jacket or capsule 60.

According to the present disclosure, the arc tube is made of polycrystalline alumina or PCA. The use of PCA allows the lamp to run at higher temperatures than a quartz lamp without suffering devitrification. The outer jacket is generally made from quartz. In addition to the foregoing, standard electrode materials are used such as niobium wire, molybdenum wire, and tungsten wire. However, molybdenum tends to dissolve in the presence of a zinc fill. Therefore, it may be necessary if one desires to use molybdenum as a wire material to coat the molybdenum with tungsten. An alternative to these electrode materials is cermet (ceramic metal) materials which are known for use as electrodes.

The lamp further includes a standard fill gas component, such as argon, krypton, or xenon, that is sealed in the arc tube upon construction, and metal and metal halide components, such as CaI₂, CeI₃, TlI, NaI or other known dosing materials. These materials are generally added to the lamp in the form of pellets. The lamp of the present disclosure preferably includes a reduced amount of mercury, less than 2 mg/cc and up to 10 mg/cc zinc/zinc iodide as part of the lamp dose.

Turning now to the role of mercury in metal halide lamps, one function of mercury is as a voltage generator. In order for a metal halide lamp to operate on commercial power supplies, the lamp needs to have a voltage of around 90 volts. For most chemicals that would be used for the lamp dose, voltage is directly proportional to vapor pressure. Mercury proves to be an ideal voltage generator because mercury exhibits a low vapor pressure when the metal halide lamp is cold, therefore making it easier to start the lamp, and a higher vapor pressure when the lamp is hot, providing the voltage necessary to supply power into the lamp per the intended lamp use. In essence, the voltage of a lamp must be controlled to achieve the proper power level and operate via conventional ballast circuitry. Mercury has historically been used as a part of the lamp dosing system because it tends to raise operating voltages to the required level easily. With a lower mercury content metal halide fill, however, one would expect that some of this benefit may be sacrificed. In accord with the present disclosure this sacrifice in voltage generation is offset by increasing the aspect ratio of the lamp up to about 4.75. By way of comparison, conventional lamps exhibit an aspect ratio of closer to 1. The increase in the aspect ratio is preferably achieved by lengthening the lamp. This provides for a larger voltage drop. This is offset by also decreasing the lamp bore diameter, which reduces surface area, and wall loading which is defined herein as the lamp power divided by the surface area in the region of the gap. Optimally, the lamp according to the invention exhibits an aspect ratio of up to 4.75 and a wall loading in excess of 35 W/cm².

The voltage of the lamp is directly proportional to the length at fixed pressure. If the length of the lamp is increased then the vapor pressure can be decreased while a constant voltage may be maintained. This effect may be achieved by reducing the amount of mercury in a metal halide lamp.

In addition to its role as a voltage generator, the mercury content in a metal halide lamp also functions as a buffer gas. The job of a buffer gas is to insulate the arc to reduce heat loss and allow for a higher arc temperature to be maintained. The higher arc temperature and reduced heat loss also advantageously extend lamp life and enhance lamp performance. Historically, mercury has been a good buffer gas of choice because it efficiently insulates the arc from heat loss. Therefore a reduction in mercury may also reduce the insulation properties and cause greater heat loss. The foregoing may be counteracted by the addition of an additional rare gas which serves to buffer the arc and provide optimal pressure.

A further function of mercury in the metal halide lamp is associated with the control of the production of molecular iodine (I₂), or free iodine. Metal iodides are often used as fill in metal halide lamps and dissociate during normal operation, thus producing free iodine. This free iodine tends to absorb visible light and makes starting the lamp more difficult. Mercury, however, reacts with free iodine to form mercury iodide, HgI₂, which absorbs visible light. I₂ interference with starting is therefore also avoided when mercury is included in the fill. A reduction in mercury content, therefore, allows for greater free iodine content and less transmission of visible light. However. it has been determined that reducing mercury to a lower content level, of up to about only 2 mg/cc, and even down to 0.3 mg/cc, is sufficient to eliminate most of the free iodine produced in a standard lamp. Reduction in mercury content is further aided by the increased aspect ratio, up to 4.75, which limits the volume of the lamp and, therefore, requiring even less mercury in the lamp fill. Moreover, I₂ is also reduced by the presence of zinc metal in the dose.

The subject application replaces mercury to some degree with a fill of zinc and/or zinc iodide. The zinc provides vapor pressure substantially similar to mercury and partially vaporizes when the lamp is hot. Zinc also advantageously remains solid at room temperature, thus allowing an increased amount of zinc or zinc iodide to be added to the metal halide lamp as compared to a rare gas, such as xenon, which is still in the gas phase even when the lamp is cold. The amount of a gas such as xenon that can be added is limited by the lamp size and configuration due to the fact that the xenon remains in the gaseous phase.

Also important to the foregoing is the material from which the lamp vessel is made. Standard silica or quartz lamp envelopes tend to devitrify over time due to high operating temperatures. Polycrystalline alumina, however, does not devitrify at high operating temperatures, therefore allowing the use of higher vapor pressure halides which operate at higher operating temperatures. Increased operating temperatures translate into the capability for the lamp to maintain optimal voltage and to produce increased lumens per watt, balanced with an optimal color rendition index value.

Another advantage of the addition of zinc and/or zinc iodide in combination with mercury results in a lamp having less than 3 picograms of mercury per lumen hour as compared to a conventional metal halide lamp which has 20 to 100 picograms of mercury per lumen hour. Also a factor in achieving this low picogram mercury per lumen hour value is the high aspect ratio of the lamp configuration disclosed herein.

Alteration of the lamp dose may improve the target value, for example, of 89 lumens per watt performance of the metal halide lamp of this disclosure. Changes in the dose of the lamp, or the fill of the lamp. will result in a tradeoff between lumens per watt and color rendering index. Therefore, as one skilled in the art considers whether it is more important to have greater lumens per watt or improved color rendering index, the dosing of the lamp may be altered accordingly. CRI, or color rendering index, is a standard metric used in the lamp industry. Mercury tends to broaden the sodium emission of lamps into red color wavelengths and improves the CRI. Therefore, a reduction in mercury may, to some degree, alter the CRI of a lamp.

Table 1 below provides 0-hour data. Some depreciation in performance was evident after 100-hour testing of selected samples where the zinc metal acting with other iodide components pulls the I₂ from the fill and results in a color shift.

TABLE 1

| | | Volt- | | Lu- | | | | |
|---|---|---|---|---|---|---|---|---|
| Lamp# | Cell | age | LPW | mens | CCX | CCY | CCT | CRI |
| 723 | Low Hg (0.3 | 95.0 | 95.2 | 6643 | 0.435 | 0.409 | 3079 | 85.8 |
| | mg) | | | | | | | |
| 725 | Low Hg (0.3 | 84.1 | 94.3 | 6594 | 0.434 | 0.410 | 3097 | 84.2 |
| | mg) | | | | | | | |
| 727 | Low Hg (0.3 | 82.4 | 93.9 | 6563 | 0.443 | 0.405 | 2901 | 80.7 |
| | mg) | | | | | | | |
| 729 | Low Hg (0.3 | 98.8 | 92.4 | 6459 | 0.443 | 0.402 | 2889 | 85.3 |
| | mg) | | | | | | | |
| 731 | Low Hg (0.3 | 95.9 | 90.9 | 6370 | 0.436 | 0.410 | 3062 | 86.1 |
| | mg) | | | | | | | |
| Avg | | 91.2 | 93.3 | 6526 | 0.438 | 0.408 | 3005 | 84.4 |
| SD | | 7.5 | 1.7 | 110 | 0.004 | 0.004 | 102 | 2.2 |
| 701 | No Hg | 90.1 | 88.7 | 6218 | 0.445 | 0.403 | 2855 | 82.5 |
| 702 | No Hg | 94.2 | 89.9 | 6310 | 0.447 | 0.403 | 2828 | 83.4 |
| 703 | No Hg | 97.0 | 85.4 | 5995 | 0.445 | 0.401 | 2841 | 83.6 |
| 705 | No Hg | 90.2 | 89.8 | 6271 | 0.452 | 0.400 | 2729 | 81.5 |
| 709 | No Hg | 91.8 | 88.0 | 6157 | 0.446 | 0.401 | 2825 | 82.8 |
| Avg | | 92.7 | 88.4 | 6190 | 0.447 | 0.402 | 2816 | 82.8 |
| SD | | 3.0 | 1.8 | 123 | 0.003 | 0.001 | 50 | 0.8 |

### Where low Hg=(0.3 mg)

LPW=lumens per watt
SD=standard deviation

### CCX=

CCT=correlated color temperature
CRI=color rendering index

Table 2 provides similar data that demonstrates variation of the content of zinc metal and zinc oxide and the effect thereof on lamp performance.

TABLE 2

| | | | Halide | | | | | |
|---|---|---|---|---|---|---|---|---|
| | Zn | ZnI2 | Weight | | | | | |
| Lamp | (mg) | (mg) | (mg) | Voltage | LPW | Lumens | CCT | Ra |
| 800 | 0.5 | 0 | 4.5 | 69.3 | 87.5 | 6129 | 3151 | 78.3 |
| 801 | 0.5 | 0 | 4.5 | 60.6 | 90.5 | 6336 | 3275 | 74.7 |
| 806 | 0.5 | 0.2 | 3 | 66.6 | 92.6 | 6482 | 3156 | 76.5 |
| 807 | 0.5 | 0.2 | 3 | 76.0 | 85.9 | 6006 | 3149 | 78.4 |
| 812 | 0.5 | 0.2 | 6 | 67.4 | 87.2 | 6113 | 3193 | 74.8 |
| 813 | 0.5 | 0.2 | 6 | 71.2 | 87.6 | 6138 | 3258 | 76.1 |
| 818 | 0.5 | 0.4 | 4.5 | 84.6 | 92.3 | 6462 | 3105 | 77.7 |
| 819 | 0.5 | 0.4 | 4.5 | 88.9 | 90.7 | 6395 | 3135 | 79.9 |
| 824 | 1.25 | 0.4 | 3 | 100.5 | 92.2 | 6454 | 2985 | 82.4 |
| 825 | 1.25 | 0.4 | 3 | 96.4 | 88.4 | 6188 | 2865 | 80.4 |
| 831 | 1.25 | 0 | 6 | 88.3 | 86.9 | 6073 | 2903 | 82.5 |
| 836 | 1.25 | 0.2 | 4.5 | 116.1 | 79.4 | 5567 | 2965 | 86.2 |
| 837 | 1.25 | 0.2 | 4.5 | 88.1 | 86.7 | 6066 | 3008 | 83.0 |
| 842 | 1.25 | 0 | 3 | 83.1 | 89.3 | 6227 | 2990 | 84.4 |
| 843 | 1.25 | 0 | 3 | 81.1 | 87.6 | 6134 | 3046 | 82.9 |
| 848 | 1.25 | 0.4 | 6 | 104.7 | 81.0 | 5683 | 3077 | 82.2 |
| 849 | 1.25 | 0.4 | 6 | 124.2 | 84.9 | 5987 | 3069 | 84.3 |
| 855 | 2 | 0 | 4.5 | 93.7 | 83.8 | 5868 | 3013 | 86.5 |
| 860 | 2 | 0.2 | 3 | 105.7 | 83.1 | 5820 | 3143 | 82.8 |
| 861 | 2 | 0.2 | 3 | 108.3 | 87.4 | 6130 | 3042 | 84.6 |
| 867 | 2 | 0.2 | 6 | 102.6 | 82.8 | 5798 | 2958 | 84.2 |

TABLE 3
GE 70 W; Polycrystalline alumina arc tube; argon fill, and dose of
DY/HO/TmNa/TI; 4 mg of Hg; LPW of 88.6; 6200 lumens; Ra = 83;
CCT = 3000; aspect ratio of 1.1; and wall loading 43 W/cm²
and
Low Hg Lamp #723, 70 W lamp; polycrystalline alumina arc tube; argon
fill; dose of Ce/Ca•Na/TI; 0.3 mg of Hg; 94.9 LPW; 6643 lumens;
Ra = 85; CCT = 3079; aspect ratio of 1.6; and wall loading 45 W/cm²

The invention has been described with reference to the preferred embodiments. Obviously, modifications and alterations will occur to others upon reading and understanding the preceding detailed description. It is intended that the invention be construed as including all such modifications and alterations.

What is claimed is:

1. A metal halide lamp comprising:
a ceramic arc tube having an aspect ratio ranging from approximately 1.15 to approximately 4.75;
a low mercury fill in the arc tube; and
up to about 10 milligrams per cubic centimeter of zinc and/or zinc/zinc iodide.

2. The metal halide lamp of claim 1 wherein the fill contains up to one milligram mercury per cubic centimeter.

3. The metal halide lamp of claim 1 wherein the wall loading of the lamp is approximately 30 watts per square centimeter.

4. The metal halide lamp of claim 1 wherein the arc tube is polycrystalline alumina.

5. The metal halide lamp of claim 1 wherein the mercury content is on the order of up to 2 milligrams mercury per cubic centimeter.

6. A low mercury ceramic metal halide lamp comprising:
a ceramic arc tube having an arc chamber that receives first and second electrodes in spaced relation that define an arc length therebetween, and the arc tube chamber having a diameter, wherein the arc length divided by the diameter ranges from 1.15 to 4.75; and
a fill including mercury in the range of approximately 2 milligrams per cubic centimeter and up to approximately 10 milligrams per cubic centimeter of zinc or zinc/zinc iodide.

7. The lamp of claim 6 wherein the wall loading of the lamp is approximately 30 watts per square centimeter.

8. A method of making a low mercury lamp comprising:
providing a body having first and second electrodes spaced apart by an arc gap extending into a discharge chamber of a predetermined diameter formed in the body, wherein the body has an aspect ratio (defined as the arc gap divided by the diameter) on the order of approximately 1.15 to 4.75;
introducing a fill in the discharge chamber having up to 2 milligrams per cubic centimeter of mercury; and
adding up to 10 milligrams per cubic centimeter of zinc and/or zinc/zinc iodide to the fill.
